(19) United States
(12) Patent Application Publication
(10) Pub. No.: US 2010/0304003 A1
(43) Pub. Date: Dec. 2, 2010

(54) PET FOOD COMPOSITION

(76) Inventors: Kim Friesen, Carthage, IN (US); Ryan Yamka, Topeka, KS (US); Inke Paetau-Robinson, Auburn, KS (US)

Correspondence Address: COLGATE-PALMOLIVE COMPANY, 909 RIVER ROAD, PISCATAWAY, NJ, 08855, US

(21) Appl. No.: 12/679,155

(22) PCT Filed: Dec. 22, 2008
(86) PCT No.: PCT/US08/87966

§ 371 Date: Aug. 23, 2010

Related U.S. Application Data
(60) Provisional application No. 61/015,800, filed on Dec. 21, 2007.

(51) Int. Cl. A23J 1/00

(52) U.S. Cl. 426/656

(57) ABSTRACT

The present invention relates to a pet food composition having amino acids in an amount at least 7% by weight of the formulation and less than about 1% phosphorous by weight of the formulation.

This application claims benefit of U.S. Provisional No. 61/015,800 filed Dec. 21, 2007 which is hereby incorporated by reference in its entirety for all purposes.

### BACKGROUND OF THE INVENTION

This invention relates generally to pet foods and more particularly to cat foods. Optimal health is likely to play a role in decreasing the risk and delaying the onset of degenerative diseases later in the life of animals. Chronic oxidative stress is associated with the development of degenerative diseases, e.g. heart disease, cancer, and diabetes. Oxidative stress is due to an imbalance of oxidants, e.g., free radicals that are byproducts of normal metabolism, and antioxidants. Enhancing an animal's antioxidant status can potentially extend disease-free life and improve quality of life. Dietary vitamin E has been shown to maintain or improve the antioxidant status of dogs. In older dogs it has been shown that dietary antioxidants can enhance cognitive function in cats and dogs.

Maintaining healthy kidneys, cardiovascular system, and eyes are important to ensure quality of life and longevity. Inflammation contributes to acute kidney injury. Fish oil contains long-chain polyunsaturated fatty acid (LCPUFA), e.g., eicosapentaenoic acid (EPA) and docosahexaenoic acid (DHA), with anti-inflammatory properties. Additionally, fish oil has been shown to prevent coronary artery disease, fatal myocardial infarction and sudden cardiac death by its antiarrhythmic effects. Optimal body weight and body composition play a role in reducing stress on joints and ligaments, thus decreasing the risk of developing osteoarthritis. Fish oil is believed to alleviate problems associated with arthritis.

Optimal nutrition with adequate supply of nutrients is essential to maintain health and reduce the risk of developing degenerative diseases at an early age. When talking about health and healthy aging, one has to consider the whole animal with its intricate system of organs, networks and communication pathways.

Chronic oxidative stress has been associated with the development of degenerative disease, e.g., heart disease, cancer, and diabetes. Oxidative stress in cells results when an imbalance in oxidants to antioxidant defense system occurs. The generation of oxidants in cells occurs during normal metabolism such as mitochondrial electron transport and peroxisomal-oxidation of fatty acids. Phagocytes, e.g., macrophages and neutrophils, may generate oxidants as part of their host defense system. The body has endogenous antioxidants, e.g., vitamin E and glutathione, and repair systems that are able to repair oxidative damage. Overall, positive and negative feedback between the generation of oxidants, antioxidant defenses, and oxidative damage repair determines the outcome of aging. Dietary vitamin E has been shown to improve the antioxidant status of dogs. Improvement in the antioxidant status can potentially extend disease-free life and improve quality of life of cats. Additionally, fish oil has been associated with the prevention of coronary artery disease, fatal myocardial infarction and sudden cardiac death by its antiarrhythmic effects, and is believed to alleviate inflammatory joint pain associated with arthritis. In a feline chondrocyte model, DHA has been shown to decrease cartilage degradation.

### SUMMARY OF THE INVENTION

In one aspect, a pet food formulation is provided comprising a level of amino acids that is at least 7% by weight of the pet food formulation and a reduced level of phosphorus, less than about 1% by weight of the formulation.

In another aspect, a pet food is provided comprising a group of amino acids chosen from leucine, isoleucine, lysine, methionine, cystine and combinations thereof in an amount that is at least 7% by weight of the pet food formulation.

In another aspect, a pet food formulation comprising lysine levels in the range of about 2% to about 3.5% by weight of the formulation is provided.

In another aspect, a method is provided whereby the oxidative stress of an animal is reduced, comprising incorporating a pet food formulation comprising a group of amino acids having at least 7% by weight of the pet food formulation and a reduced level of phosphorus, less than about 1% by weight of the formulation.

In another aspect, a pet food formulation comprising levels of the amino acids select group ranges of about 22% to about 30% of the dietary protein level in the formulation is provided.

In another aspect, the eicosapentaenoic acid (EPA) level of the pet food formulation is in the range of about 0.15% to about 0.3% of the formulation.

In another aspect, a pet food formulation comprising a ratio of EPA to docosahexaenoic acid (DHA) ranges of about 1.2 to about 2.5 is provided.

### DETAILED DESCRIPTION

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

Exemplary embodiments of pet foods and methods of manufacturing the pet foods are described below. Although exemplary embodiments are described herein, the pet food and methods are not limited to those specific embodiments. In particular, although extruded pet food is described in detail, it should be understood that the below described invention is applicable to canned foods as well as baked dry foods.

Protein may be supplied by any of a variety of sources known by those skilled in the art, including plant sources, animal sources, or both. Animal sources include, for example, meat, meat by-products, seafood, dairy, eggs, etc. Meats include, for example, the flesh of poultry, fish, and mammals (e.g., cattle, pigs, sheep, goats, and the like). Meat by-products include, for example, lungs, kidneys, brain, livers, and stomachs and intestines (freed of all or essentially all their contents). The protein can be intact, almost completely hydrolyzed, or partially hydrolyzed. Additional protein sources include proteins from vegetable matters, such as soybeans, corn gluten and others, and from dairy products such as whey and casein. It is understood that the pet is adequately supplied with critical amino acids such as L-taurine, methionine and lysine and cystine in its ration.

Lysine and cystine may be purchased commercially or may be prepared from any suitable source. One useful lysine is Liquid Lysine 60. Pure crystalline amino acids are readily available commercially and may be used since they have a high digestibility and high absorption by the gastrointestinal system of a feline. As used herein, the terms lysine and cystine include the free acid, analogs and/or water soluble salt forms respectively of amino acids lysine and cystine.

Useful lysines include those from poly-amino acids consisting in whole or in part of lysine including Poly-D-lysine hydrobromide, molecular weight about 70,000 to about 150,000; Poly-L-lysine hydrochloride, molecular weight about 15,000 to about 30,000; Poly-L-lysine hydrobromide, molecular weight about 150,000 to about 300,000; and Poly (Lys, Phe) 1:1 hydrobromide, molecular weight about 20,000 to about 50,000 daltons. The amounts of lysine and cystine employed in the diet or ration to the gastro-intestinal system of the feline will vary depending on a number of factors including type of cat, age of cat, cat food used, protein level in the diet, degree of lean body mass protection desired, and other factors.

In one embodiment, the pet food formulation comprises cystine levels in the range of about 0.5% to about 0.75% by weight of the formulation. More particularly, the pet food formulation comprises cystine levels in the range of about 0.55% to about 0.66% by weight of the formulation. Further, the pet food formulation comprises cystine levels in the range of about 1.2% to about 2.6% by weight of the dietary protein level of the formulation. In addition, the pet food formulation comprising cystine levels in the range of about 1.4% to about 2.4% of the dietary protein level of the feline diet are fed to a cat to provide beneficial lean body mass protection.

Additionally, or in the alternative, the pet food formulation comprises lysine levels in the range of about 2% to about 3.5% by weight of the formulation. Further, the pet food formulation comprises lysine levels in the range of about 6% to about 12.5% by weight of the dietary protein level of the formulation.

Additionally, or in the alternative, the pet food formulation comprises leucine levels in the range of about 3.5% to about 5.5% by weight of the formulation. More particularly, the pet food formulation comprises leucine levels in the range of about 3.9% to about 4.8% by weight of the formulation. Further, the pet food formulation comprises leucine levels in the range of about 9.0% to about 13.5% by weight of the dietary protein level of the formulation. In addition, the pet food formulation comprises leucine levels in the range of about 10% to about 12% by weight of the dietary protein level of the formulation.

Additionally, or in the alternative, the pet food formulation comprises a total amount of select amino acids chosen from leucine, isoleucine, lysine, methionine, cystine and combinations thereof in the range of about 8% to about 13.5% by weight of the formulation. More particularly, the pet food formulation comprises a total amount of select amino acids ranges of about 9% to about 11% by weight of the formulation. Further, the pet food formulation comprises levels of the amino acids select group ranges of about 22% to about 30% by weight of the dietary protein level of the formulation. In addition, the pet food formulation comprises a select amino acid group levels in the range of about 24% to about 28% by weight of the dietary protein level of the formulation.

Additionally, or in the alternative, the eicosapentaenoic acid (EPA) level of the pet food formulation is in the range of about 0.15% to about 0.3% by weight of the formulation. More particularly, the pet food formulation comprises EPA levels in the range of about 0.2% to about 0.25% by weight of the formulation. Further, the pet food formulation comprises a ratio of EPA to docosahexaenoic acid (DHA) ranges of about 1.2 to 2.5 and preferably of about 1.5 to 2.0.

Additionally, or in the alternative, the pet food formulation comprises a phosphorus level less than 1%, preferably between about 0.5 and about 0.9% and more preferably between about 0.7 and about 0.8%. Additionally, or in the alternative, the pet food formulation comprises n-6 and n-3 fatty acids in a ratio of less than about 7:1.

In one embodiment, lysine and/or cystine are intimately mixed with the feline food. In one embodiment, the amino acid(s) are diluted prior to incorporating the amino acid(s) with the feline food. The diluent is one of a solid and a liquid, is compatible with the amino acid(s) and feline food, and is palatable, non-adverse, and gastro-intestinally acceptable to, and safe for eating by, the feline. The amino acid(s) may be admixed with the feline food by normal mixing of amino acids with the feline food. Further, an auxiliary component may be added to a feline food which has the supplemental amino acid(s) incorporated therein or therewith. This addition may be accomplished by applying the auxiliary components as a coating to the food product.

The antioxidant status of the cat was measured by determining reduced and oxidized glutathione in white blood cells, serum vitamin E concentrations, and plasma alkenal concentrations. Additionally, increased serum vitamin E concentrations are indicative of enhance immune system function. Measurements obtained by DXA, i.e. bone mineral content, bone mineral density, and percent lean tissue, were used as indicators of strong hones, joints, and muscle. Total body weight is important to support ideal joint health. The final measure included as a component of the joint health index was the serum concentration of DHA. DHA has been related to reduced cartilage damage in vitro. Organ health was evaluated by assessing kidney, heart, and eye health. Clinical measures of kidney health changes in blood urea nitrogen, creatinine, and phosphorous were included in the health index. Dietary and plasma concentrations of taurine have been linked to heart abnormalities, e.g., dilated cardiomyopathy. Therefore, whole blood taurine levels were utilized to determine taurine status and as an indicator for heart health. In addition, taurine plays a role in retinal health.

### Example

An 18-month feeding study enrolled 62 cats that were 1 year of age at the time of enrollment and determined to be healthy by physical examination and blood chemistry. The cats were cared for in accordance with Institutional Animal Care and Use Committee protocols. Additionally, cats were offered enrichment toys, received routine grooming, and had daily opportunity to socialize with other cats and people. The cats were assigned to one of four treatments: 1) formulation #1 in accordance with this invention and 2) formulations #2, #3 and #4 sold commercially. All formulations were fed according to manufacturer recommendations. The nutrient composition of each formulation is presented in Table 1.

Whole blood was collected from the cats of each group at days 0, 30, 90, 180, 365, and 533, immediately placed on ice, and then centrifuged to separate serum or plasma which was stored at −70° C. until analyzed. Serum vitamin E was analyzed using the method by Hoehler et al. Serum fatty acids were analyzed using modified methods described by Rodriguez-Palmero et al. and Folch et al. The analytical method to determine concentrations of reduced and oxidized glutathione in white blood cells was adapted from the methods described by Hagen (unpublished), Fariss et al., and Jones et al. Whole blood taurine was analyzed by a commercial laboratory (Eurofins Scientific, Inc., Memphis, Tenn.) using a proprietary method. Total alkenal concentrations were analyzed using a spectrophotometric assay on a robotic chemical analyzer by a commercial laboratory (Genox Corporation, Baltimore, Md.). Blood chemistry screen was analyzed using an automatic blood chemistry analyzer (Hitachi 912) following the manufacturers protocols. Body composition was determined by dual energy X-ray absorptiometry (DXA) on days 0, 180, 365, and 533.

Feline healthy aging was accessed by measuring individual indicators of biological change associated with organ health, antioxidant/immune status, joint health, and weight maintenance. The variables that were utilized to derive the health index included concentrations of serum vitamin E, serum alkaline phosphatase, serum alanine amino transferase, blood urea nitrogen, cholesterol, creatinine, phosphorous, whole blood taurine, triacylglycerols, DHA, EPA, and alpha-linolenic acid. Additionally, ratios of reduced to oxidized glutathione and n3 fatty acid to alkenals ratio were included in the health index. Indicators for strong bones and healthy joints were obtained from the DXA analysis and included bone mineral content, bone mineral density, percent of lean tissue, amount of adipose tissue, lean:fat ratio, and body weight.

Sixty two cats completed the study. Serum vitamin E concentrations in cats receiving the Formulation #1 were significantly higher than in cats receiving Formulation #2 or Formulation #3 diets at days 30, 180, 365, and 533. Serum vitamin E concentrations in the Formulation #1's fed cats were lower than in the cats receiving Formulation #4. The difference was significant at days 30 and 180 but not at days 365 and 533 (Table 2). The plasma concentrations of total alkenals were highest in the Formulation #1's fed cats which was significant at day 180 versus cats fed Formulation #2 or Formulation #3 diets. Formulation #1's fed cats had the lowest concentrations of alkenals relative to the concentration of LCPUFA (Table 2). The ratio of reduced glutathione to oxidized glutathione was the highest in the Formulation #1's fed cats. (Table 2).

The antioxidant status of the cat was measured by determining reduced and oxidized glutathione in white blood cells, serum vitamin E concentrations, and plasma alkenal concentrations. Glutathione is a measure of the body's ability to sequester free radicals. An increased concentration of reduced glutathione indicates that the body is better able to ward off oxidative stress. Glutathione plays a role in protecting mitochondria from the deleterious effects of lipid peroxidation products such as 4-hydroxy-2(E)-nonenal. Vitamin E is the most effective chain-breaking lipid-soluble antioxidant; it scavenges lipid radicals during initiation and propagation of lipid peroxidation. Additionally, increased serum vitamin E concentrations are indicative of improved cognitive function and enhanced immune system function. Plasma total alkenals are measured as malondialdehyde and 4-hydroxy-2(E)-nonenal which are products of oxidative damage to the cell and degradation products of fatty acid hydroperoxides.

The ratio of reduced to oxidized glutathione was the highest in the Formulation #1 group. Serum vitamin E concentrations increased over time in cats on Formulation #1, whereas, it did not change or decreased in the other groups. Since alkenals are products of lipid peroxidation and LCPUFAs are highly susceptible to oxidation, the ratio of n3 fatty acids to alkenals present in the blood of the cats was calculated. Cats on the Formulation #1 had the lowest concentrations of alkenals relative to the concentration of n3 fatty acids suggesting that vitamin E provided some protection to fatty acids.

The Formulation #1 contained fish oil which delivers LCPUFAs such as EPA and DHA which exert anti-inflammatory properties in vivo.

Serum EPA concentrations were significantly higher in the Formulation #1 group at all time points versus the other groups (Table 3). Serum DHA concentrations were significantly higher in the experimental food group than in Formulation #2 and Formulation #3 groups at all time points. Serum DHA concentrations were higher in the Formulation #1's group versus Formulation #4 group but the difference was significant only at day 180.

Body weight and body composition are important factors ensuring joint health. Muscle (lean) tissue is important to support the joints; whereas, overweight in animals puts unnecessary stress on the joints which, in turn, increases the risk of developing osteoarthritis. Cats fed the Formulation #1 had the highest percentage of lean tissue and the highest lean to fat ratio. Cats in the Formulation #1 group had a lower body weight than the cats in the other groups.

The study measured individual indicators of biological change associated with antioxidant/immune status, joint health, organ health, and weight maintenance. Serum EPA concentrations were significantly higher in Formulation #1's fed cats at all time points versus in the cats fed the competitor products (Table 3). Serum DHA concentrations were significantly higher in Formulation #1's fed cats than in Formulation #2 or Formulation #3 fed cats at all time points. Serum DHA concentrations were significantly higher in Formulation #1's fed cats versus Formulation #4 fed cats at day 180.

Table 4 shows results from the DXA measurement at days 90, 180, 365, and 533. Cats fed the Formulation #1 had the highest percentage of lean tissue and the highest lean to fat ratio. Cats receiving the Formulation #1 had significantly less adipose tissue and a lower body weight compared to the Formulation #2 fed cats at day 533.

Results from the blood chemistry analysis are shown in Table 5. Cats fed the Formulation #1 had lower serum creatinine concentration compared to each of the other groups. The difference was significant versus Formulation #2 and Formulation #4 fed cats at all time points and at day 533, respectively. Serum phosphorous concentrations were low in the Formulation #1's fed cats compared to the other groups. The difference was significant only at day 365 versus the Formulation #2 fed cats. Blood urea nitrogen was lowest in the Formulation #1's fed cats. This difference was significant versus Formulation #3 fed cats at days 30, 90, 180, and 533. Including all of the above mentioned measurements in the calculation to the feline healthy aging index, this study demonstrated the overall health of the adult cats on the Formulation #1 improved compared to the other groups.

While the invention has been described in terms of various specific embodiments, those skilled in the art will recognize that the invention can be practiced with modification within the spirit and scope of the claims.

TABLE 1
Analyzed nutrient profile of the formulations

| Nutrients, 100% Dry | Formula- | Formula- | Formula- | Formula- |
|---|---|---|---|---|
| Matter Basis | tion #1 | tion #2 | tion #3 | tion #4 |
| Crude Protein, % | 37.15 | 33.78 | 33.75 | 32.17 |
| Fat, % | 18.02 | 23.71 | 14.65 | 17.38 |
| Crude Fiber, % | 3.32 | 2.16 | 2.14 | 3.24 |
| Ca, % | 0.95 | 1.19 | 1.86 | 1.41 |
| P, % | 0.73 | 1.02 | 1.33 | 1.18 |
| Ash, % | 5.46 | 6.70 | 8.08 | 8.14 |
| EPA, % | 0.21 | 0.10 | 0.04 | 0.08 |
| DHA, % | 0.14 | 0.11 | 0.05 | 0.09 |
| Alpha-Linolenic acid, % | 0.18 | 0.20 | 0.13 | 0.18 |
| Linoleic Acid, % | 3.31 | 4.07 | 1.89 | 3.48 |
| Arachidonic acid, % | 0.09 | 0.15 | 0.05 | 0.10 |
| Total n-3 fatty acids, % | 0.64 | 0.52 | 0.25 | 0.41 |
| Total n-6 fatty acids, % | 3.52 | 4.38 | 2.00 | 3.69 |
| N6:n3 ratio | 5.5:1 | 8.4:1 | 8:1 | 9:1 |
| Leucine, % | 4.03 | 2.43 | 2.90 | 2.54 |
| Isoleucine, % | 1.27 | 0.97 | 0.89 | 0.89 |
| Lysine, % | 2.35 | 1.79 | 1.31 | 1.44 |
| Methionine, % | 1.42 | 1.11 | 0.75 | 1.12 |
| Cystine, % | 0.52 | 0.38 | 0.46 | 0.41 |
| Vitamin E, IU/kg | 546.9 | 130.6 | 64.1 | 709.7 |

TABLE 2
Concentrations of serum vitamin E, plasma
alkenals, and whole blood taurine

| | | Formula- | Formula- | Formula- | Formula- |
|---|---|---|---|---|---|
| | Day | tion #1 | tion #2 | tion #3 | tion #4 |
| Serum Vitamin | 30 | 20.89 | 17.2 | 9.96 | 28.4 |
| E (g/mL) | 180 | 23.03 | 17.03 | 12.33 | 30.86 |
| | 365 | 24.2 | 18.31 | 12.15 | 27.68 |
| | 533 | 24.43 | 17.03 | 12.08 | 27.82 |
| Alkenals (M) | 30 | 2.59 | 2.55 | 2.05 | 2.35 |
| | 180 | 3.98 | 3.27 | 3.15 | 3.66 |
| | 365 | 3.05 | 2.65 | 2.66 | 2.4 |
| | 533 | 2.21 | 2.72 | 2.02 | 2.41 |
| n3 FA:Alkenal | 30 | 2.83 | 2.98 | 3.18 | 4.58 |
| Ratio | 180 | 4.77 | 2.98 | 2.92 | 3.08 |
| | 365 | 6.88 | 4.12 | 3.45 | 4.85 |
| | 533 | 8.39 | 4.52 | 2.47 | 4.95 |
| Whole blood | 30 | 417.27 | 396.88 | 490 | 428.57 |
| Taurine | 180 | 407.73 | 350.63 | 390 | 388.75 |
| (nmol/mL) | 365 | 384.55 | 344.67 | 391.88 | 358.75 |
| | 533 | 427.17 | 421.33 | 495 | 433.13 |
| GSH:GSSG | 30 | 19.81 | 19.32 | 17.99 | 20.2 |
| | 180 | 15.31 | 13.42 | 10.93 | 14.36 |
| | 365 | 22.49 | 16.47 | 17.7 | 17.36 |
| | 533 | 33.8 | 31.45 | 33.8 | 30.08 |

TABLE 3
Mean concentrations of selected serum fatty acids.

| | | mg/dL | | | |
|---|---|---|---|---|---|
| | | Formula- | Formula- | Formula- | Formula- |
| | Day | tion #1 | tion #2 | tion #3 | tion #4 |
| Linoleic | 180 | 41.02 | 48.04 | 44.01 | 53.64 |
| acid(18:2 n6) | 365 | 46.38 | 55.49 | 49.71 | 54.11 |
| | 533 | 49.12 | 57.32 | 52.53 | 62.28 |
| Linolenic acid | 180 | 1.02 | 0.83 | 0.95 | 1.15 |
| | 365 | 1.16 | 0.99 | 1.13 | 1.17 |
| | 533 | 1.27 | 1.13 | 1.27 | 1.53 |
| Arachidonic | 180 | 12.79 | 21.69 | 13.87 | 16.08 |
| acid(20:4 n6) | 365 | 13.83 | 23.92 | 12.47 | 19.3 |
| | 533 | 15.15 | 24.15 | 12.25 | 19.8 |
| Eicosapentaenoic | 180 | 10.32 | 3.22 | 3.08 | 3.61 |
| acid(20:5 n3) | 365 | 11.92 | 3.7 | 3.02 | 3.3 |
| | 533 | 9.44 | 3.39 | 0.75 | 3.63 |
| Docosahexaenoic | 180 | 7.65 | 5.68 | 5.18 | 6.53 |
| acid(22:6 n3) | 365 | 7.9 | 6.22 | 5.02 | 7.18 |
| | 533 | 7.97 | 5.79 | 2.96 | 6.78 |

TABLE 4
Body composition data obtained by DXA analysis.

| | | Formula- | Formula- | Formula- | Formula- |
|---|---|---|---|---|---|
| | Day | tion #1 | tion #2 | tion #3 | tion #4 |
| Bone mineral | 90 | 2.81 | 2.78 | 2.81 | 2.66 |
| content (%) | 180 | 2.8 | 2.81 | 2.78 | 2.61 |
| | 365 | 2.82 | 2.8 | 2.81 | 2.73 |
| | 533 | 2.9 | 2.78 | 2.91 | 2.75 |
| Bone mineral | 90 | 0.61 | 0.63 | 0.62 | 0.61 |
| density | 180 | 0.61 | 0.63 | 0.62 | 0.62 |
| | 365 | 0.6 | 0.64 | 0.64 | 0.63 |
| | 533 | 0.63 | 0.65 | 0.64 | 0.63 |
| Lean tissue (%) | 90 | 75.33 | 73.89 | 74.36 | 72.47 |
| | 180 | 75.54 | 73.92 | 73.24 | 71.53 |
| | 365 | 75.41 | 72.8 | 70.43 | 70.77 |
| | 533 | 70.66 | 68.05 | 69.14 | 69.93 |
| Fat tissue (g) | 90 | 989.52 | 1127.19 | 1036.25 | 1198.75 |
| | 180 | 1051.91 | 1392.75 | 1141.94 | 1350.25 |
| | 365 | 1182.09 | 1339.87 | 1313.25 | 1368.25 |
| | 533 | 1196.29 | 1431.2 | 1265.19 | 1264.57 |
| Lean:Fat Ratio | 90 | 4.86 | 4.18 | 4.35 | 3.62 |
| | 180 | 4.88 | 4.22 | 4.16 | 3.48 |
| | 365 | 3.93 | 3.74 | 3.46 | 3.35 |
| | 533 | 4.28 | 2.93 | 3.32 | 3.93 |
| Scanned body | 90 | 4.73 | 5.2 | 4.72 | 5.1 |
| weight (kg) | 180 | 4.71 | 5.18 | 4.82 | 5.21 |
| | 365 | 4.81 | 5.42 | 5.04 | 5.23 |
| | 533 | 5.03 | 5.68 | 5.05 | 5.31 |

TABLE 5
Blood chemistry data at days 30, 90, 180, 365, and 533.

| | | Formula- | Formula- | Formula- | Formula- |
|---|---|---|---|---|---|
| | Day | tion #1 | tion #2 | tion #3 | tion #4 |
| Alkaline | 30 | 34.65 | 36.5 | 35.31 | 29.13 |
| Phosphatase | 90 | 33.13 | 39.31 | 37.87 | 30.13 |
| (U/L) | 180 | 29.7 | 32.06 | 33.81 | 26.25 |
| | 365 | 25.96 | 30.8 | 27.75 | 21.5 |
| | 533 | 26.13 | 35.2 | 33.38 | 29 |
| Alanine Amino | 30 | 63 | 73.25 | 52.44 | 55.88 |
| Transferase (U/L) | 90 | 73.52 | 95.06 | 62.93 | 53.63 |
| | 180 | 62.52 | 83.75 | 57.44 | 51.63 |
| | 365 | 56.57 | 76.73 | 53.31 | 50.88 |
| | 533 | 63.96 | 95.93 | 65 | 68.43 |
| Blood Urea | 30 | 23.63 | 24.73 | 27.46 | 25.84 |
| Nitrogen | 90 | 22.49 | 23.33 | 27.77 | 24.88 |
| (mg/dL) | 180 | 21.91 | 21.98 | 25.22 | 23.03 |
| | 365 | 23.39 | 22.67 | 25.06 | 22.53 |
| | 533 | 24.47 | 23.02 | 27.84 | 27.63 |
| Cholesterol | 30 | 124.96 | 157.13 | 106.25 | 149.75 |
| (mg/dL) | 90 | 128.83 | 171 | 112.47 | 155.38 |
| | 180 | 127.35 | 150.88 | 124.38 | 152.38 |
| | 365 | 155.96 | 187.4 | 142.75 | 171 |
| | 533 | 162.96 | 188.6 | 142.44 | 178 |
| Creatinine | 30 | 1.19 | 1.39 | 1.17 | 1.16 |
| (mg/dL) | 90 | 1.14 | 1.39 | 1.23 | 1.24 |
| | 180 | 1.15 | 1.33 | 1.21 | 1.25 |
| | 365 | 1.2 | 1.48 | 1.28 | 1.4 |
| | 533 | 1.11 | 1.43 | 1.23 | 1.3 |
| Phosphorus | 30 | 5.99 | 6.32 | 6.46 | 5.88 |
| (g/dL) | 90 | 5.97 | 6.39 | 6 | 5.82 |
| | 180 | 5.75 | 5.92 | 6.02 | 5.92 |
| | 365 | 5.5 | 5.95 | 5.59 | 5.54 |
| | 533 | 5.57 | 5.91 | 5.65 | 5.43 |
| Triacylglycerols | 30 | 46.39 | 69.31 | 55.94 | 40.38 |
| (mg/dL) | 90 | 36.26 | 47.44 | 52.27 | 38 |
| | 180 | 37.91 | 55.19 | 48.88 | 37.63 |
| | 365 | 56.39 | 82.27 | 74.81 | 48.38 |
| | 533 | 61.8 | 94.35 | 77.26 | 84.19 |

TABLE 6
Components of the Health Index at day 533.

| | | Formula- | Formula- | Formula- | Formula- |
|---|---|---|---|---|---|
| | | tion #1 | tion #2 | tion #3 | tion #4 |
| Serum Vitamin E (mg/mL) | Immune System | 24.43 | 17.03 | 12.08 | 27.82 |
| Alkaline Phosphatase (U/L) | Vital Organs | 26.13 | 35.2 | 33.38 | 29 |
| Alanine Amino Transferase (U/L) | Vital Organs | 63.96 | 95.93 | 65 | 68.43 |
| Blood Urea Nitrogen (mg/dL) | Vital Organs | 24.47 | 23.02 | 27.84 | 27.63 |
| Cholesterol (mg/dL) | Vital Organs | 162.96 | 188.6 | 142.44 | 178 |
| Creatinine (mg/dL) | Vital Organs | 1.11 | 1.43 | 1.23 | 1.3 |
| Phosphorous (mg/dL) | Vital Organs | 5.57 | 5.91 | 5.65 | 5.43 |
| Triacylglycerols (mg/dL) | Vital Organs | 61.8 | 94.35 | 77.26 | 84.19 |
| Whole blood Taurine (nmol/mL) | Vital Organs | 427.17 | 421.33 | 495 | 433.13 |
| Eicosapentaenoic acid (mg/dL) | Vital Organs | 9.44 | 3.39 | 0.75 | 3.63 |
| a-Linolenic acid (mg/dL) | Vital Organs | 1.27 | 1.13 | 1.27 | 1.53 |
| Lean (%) | Strong bones/joints/muscle | 70.66 | 68.05 | 69.14 | 69.93 |
| Bone mineral content (%) | Strong bones/joints/muscle | 2.9 | 2.78 | 2.91 | 2.75 |
| Bone mineral density | Strong bones/joints/muscle | 0.63 | 0.65 | 0.64 | 0.63 |
| Docosahexaenoic acid (mg/dL) | Strong bones/joints/muscle: | 7.97 | 5.79 | 2.96 | 6.78 |
| | brain/vision | | | | |
| Fat (g) | Avoid Excess Weight gain | 1196.29 | 1431.2 | 1265.19 | 1264.57 |
| Lean:Fat Ratio | Avoid Excess Weight gain | 4.28 | 2.93 | 3.32 | 3.93 |
| Body Weight (g) | Avoid Excess Weight gain | 4796.13 | 5423.4 | 4853.31 | 5048.29 |
| n3 FA:Alkenals | Antioxidant defense | 8.39 | 4.52 | 2.47 | 4.95 |
| GSSG | Antioxidant defense | 0.32 | 0.36 | 0.35 | 0.34 |
| GSH:GSSG | Antioxidant defense | 33.8 | 31.45 | 33.8 | 30.08 |

1. A pet food formulation comprising a level of amino acids of at least 7% by weight of the formulation and less than about 1% phosphorus by weight of the formulation.

2. The formulation of claim 1 wherein the amino acids are selected from a group consisting of leucine, isoleucine, lysine, methionine, cystine and combinations thereof.

3. The formulation of claim 1 comprising less than about 6% ash by weight of the formulation.

4. The formulation of claim 1 comprising at least one of an n-3 fatty acid and at least one of an n-6 fatty acid.

5. The formulation of claim 4 wherein the n-3 fatty acids comprise at least one of alpha-linolenic acid, eicosapentaenoic acid, docosapentaenoic acid or docosahexaenoic acid.

6. The formulation of claim 4, which contains n-6 and n-3 fatty acids in a ratio of less than about 7:1.

7. The formulation of claim 4 wherein the n-3 fatty acid comprises at least one of a long chain n-3 fatty acid.

8. The pet food formulation of claim 7 wherein the long-chain n-3 fatty acids is present in an amount of about 0.2% to about 0.6% of the dietary formulation.

9. The pet food formulation of claim 8 wherein the long chain n-3 fatty acids is present in an amount of at least about 0.3% to 0.4% of the dietary formulation

10. A pet food formulation comprising at least about 3.5% leucine and at least about 0.5% cystine by weight of the formulation.
